(19) United States
(12) Patent Application Publication
(10) Pub. No.: US 2014/0325670 A1
(43) Pub. Date: Oct. 30, 2014

(54) SYSTEM AND METHOD FOR PROVIDING RISK SCORE BASED ON SENSITIVE INFORMATION INSIDE USER DEVICE

(71) Applicant: Rivendale Software Solution Private Limited, Mumbai (IN)

(72) Inventors: Ashish Omprakash Singh, Mumbai (IN); Rahul Pradip Guha, Mumbai (IN)

(21) Appl. No.: 14/262,305

(22) Filed: Apr. 25, 2014

(30) Foreign Application Priority Data
Apr. 25, 2013 (IN) 1517/MUM/2013

(51) Int. Cl. G06F 21/60

(52) U.S. Cl. CPC G06F 21/60
USPC 726/26

(57) ABSTRACT

A system and method for providing risk score based on sensitive information inside user device is provided. The system includes a user, a computing device or a user device (e.g. a mobile phone, laptop, desktop, etc.), a risk scoring tool, a network, and a server. The risk scoring tool may be installed in the computing device 104 in one example embodiment. In another example embodiment, the risk scoring tool may be installed in the server. The method may facilitate the user (e.g. the system or the network administrator), to identify the devices in the network, which may contain the most sensitive information related to an enterprise or organization. The risk scoring tool may help the organization or the enterprise to prioritize their security and backup policy based on identification of the most sensitive user device in their network or group.

### BACKGROUND

1. Technical Field

The embodiments herein generally relate to data security in a computing device, for preventing file transfer from a user device and, more particularly, to a system and method for providing a risk score based on sensitive information present inside a user device.

2. Description of the Related Art

Many enterprises (e.g., corporations, partnerships, academic institutions, etc.)

maintain enterprise computer networks that allow enterprise users to access enterprise resources, such as hardware and software applications for email, customer relationship management (CRM), document management, enterprise resource planning (ERP), and the like. Also, many enterprises allow users to access the enterprise network via mobile devices, such as smartphones, tablet, computers, personal digital assistants (PDAs), etc. In some cases, software applications running on the mobile devices (e.g. also known as handheld devices) exchange data with the enterprise network, some of which can be saved on the memory hardware (e.g., hard drives, SD cards) of the mobile devices.

A growing trend among businesses is to allow employees to use their personally owned mobile devices for both, to access company resources and to access their personal applications and data. This trend, known as BYOD (bring your own device) or BYOT (bring your own technology), significantly complicates the task of protecting enterprise resources, including confidential and/or sensitive information.

Enterprise users store sensitive or confidential information related to enterprises on their desktops, laptops, smart phones and the like. The sensitive data includes information regarding customers, contracts, deliveries, supplies, users, manufacturing, etc. For example, when software code is developed by an employee of the organization, if the employee changes his job and moves to a competitor of their former employer, there are high chances that the software code developed by the employee may be taken away and implemented by the competitor. In such cases, it is imperative to protect the proprietary or confidential information from being accessed by unauthorized persons.

Furthermore, to prevent current employees of an organization from misusing sensitive/confidential information made accessible to them, it is necessary to take measures to restrict the employee from sending mails from his/her corporate email ID to his/her personal email id. Also employee should be barred from using external data storage devices, printing out documents containing sensitive/confidential information, etc. The aforementioned measures are typically termed as block policies that prevent users from initiating any action that would compromise the confidentiality of sensitive data.

As these devices continue to grow in popularity and provide an increasing number of functions, many organizations may wish to place certain controls on how these devices can be used, what resources these devices can access, and how the applications running on these devices can interact with other resources. It is also needed to identify which devices occupy most of the sensitive information, so that in case of an emergency or network crash the device with most sensitive information can be restored first. Accordingly, there remains a need for an enterprise users or network administrators to identify devices in the enterprise network or mobile devices of the enterprise users, which contain sensitive or confidential information.

### SUMMARY

The embodiment herein discloses a system for providing risk score based on sensitive information inside user device. The system includes a user, a computing device or a user device for e.g. a mobile phone, laptop, desktop, etc., a risk scoring tool, a network, and a parsing server. The risk scoring tool may be installed in the computing device in one example embodiment. In another example embodiment, the risk scoring tool may be installed in a server. The risk scoring tool includes a database, a scanning module, an information log module, and a communication module.

The scanning module scans for files and file extensions present inside the user device, to obtain information on a predefined keywords, where the predefined keywords are stored inside the database. The information log module creates a log file for said user device to record information on the scan, wherein said information comprises data on push ID, date location of said file, name of said file, extension type, sensitive content found based on the predefined keywords, and number of occurrences of the sensitive content.

The communication module transfers the log file of the user device to a server through a network. The server may be configured to receive multiple log files from plurality of the user device. The risk score calculation module, calculates the information of the log file, to obtain statistics on sensitive data present inside plurality of the user device. The user device is assigned a risk score based on the statistics. The result module lists the user devices based on the risk score. The list is displayed by the display unit.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a system view illustrating a user interacting with a risk scoring tool installed inside a computing device and the computing device interacting with a parsing server through a network according to an embodiment herein;

FIG. 2A illustrates an exploded view of the risk scoring tool of FIG. 1 according to an embodiment herein;

FIG. 2B illustrates an exploded view of the parsing server of FIG. 1 according to an embodiment herein;

FIG. 3 is a flow diagram illustrating a method for providing a risk score based on sensitive information inside a user device according to an embodiment herein;

FIG. 4 illustrates an exploded view of a receiver used in accordance with the embodiments herein; and

FIG. 5 illustrates a schematic diagram of a computer architecture according to an embodiment herein;

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned, there remains a need a need for an enterprise users or network administrators to identify devices in the enterprise network or mobile devices of the enterprise users, which contain sensitive or confidential information. The embodiments herein achieve this by providing a technique for assigning a risk score to a user device based on sensitive information present inside the user device.

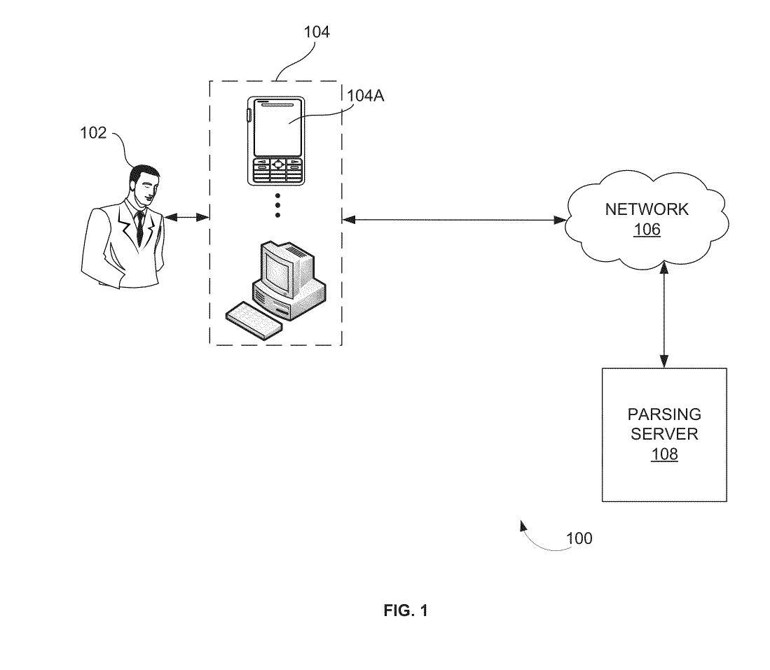

A user may use his own personal computing devices, for example mobile devices, such as smartphones, tablet, laptop, computers, personal digital assistants (PDAs), etc. but not limited to embodiments mentioned herein. The user may be an employee of an organization or an enterprise who may bring his own personal computing device, for both personal and official use. Alternatively, the user may be a system or a network administrator, who is managing the network for the organization or enterprise, etc. Referring now to the drawings, and more particularly to FIGS. 1 through 5, where similar reference characters denote corresponding features consistently throughout the figures, preferred embodiments are shown.

FIG. 1 is a system view 100 illustrating a user 102 interacting with a risk scoring tool 104A installed inside a computing device 104 and the computing device interacting with a parsing server through a network according to an embodiment herein. The system view 100 may include a user 102, a computing device or a user device 104 (e.g. a mobile phone, laptop, desktop, etc.), a risk scoring tool 104A, a network 106, and a parsing server 108. The risk scoring tool 104A may be installed in the computing device 104 in one example embodiment. In another example embodiment, the risk scoring tool 104A may be installed in a server (e.g. the parsing server 108).

The computing device 104 may be a personal device used by the user 102 in an enterprise environment. The parsing server 108 may include a communication link to the network 106. The parsing server 108 may interact with the user device 104 through the network 106. The risk scoring tool 104A may support various operating systems installed in the computing device 104, such as Android®, iOS®, RIM®, Windows®, etc.

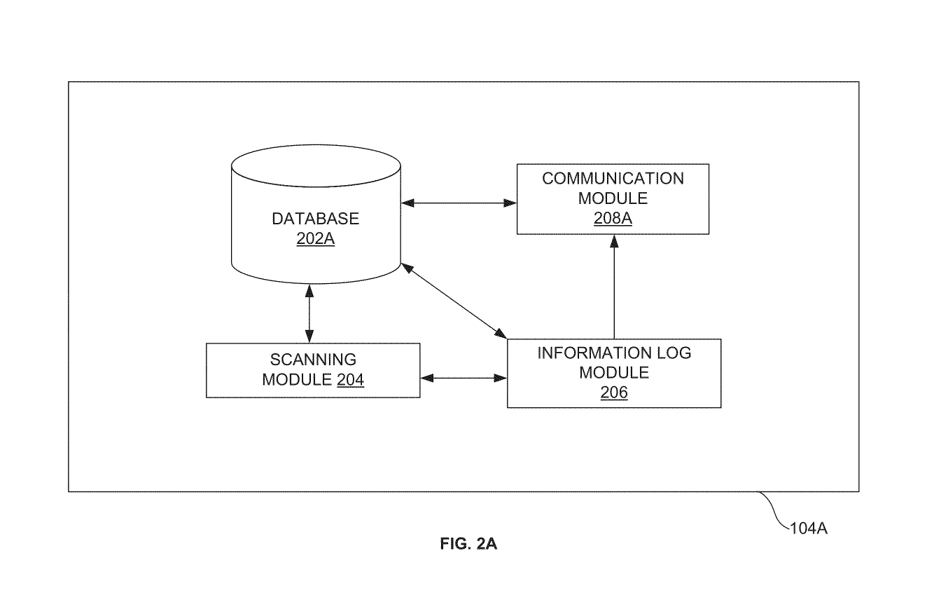

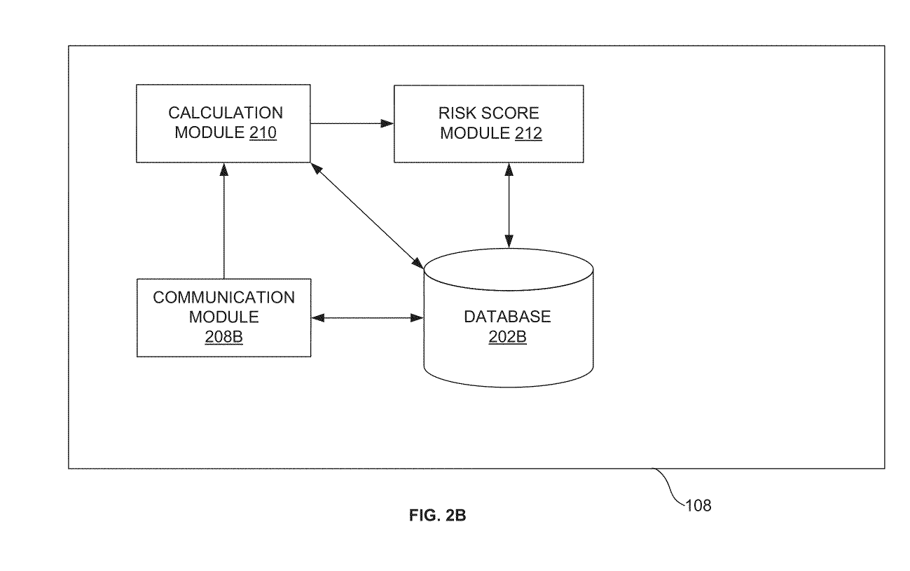

FIG. 2A illustrates an exploded view of the risk scoring tool 104A of FIG. 1 according to an embodiment herein. The risk scoring tool 104A may include a database 202A, a scanning module 204, an information log module 206, and a communication module 208A. The risk scoring tool 104A may be installed in the user device 104. The database 202A may store keywords related to confidential, critical or sensitive data related to the organization or the enterprise. The keywords may include intellectual property, confidential, shares, finance, patents, process flow, remuneration, etc. which may be construed as sensitive information for the organization or enterprise, in one example embodiment.

The scanning module 204 may scan files and file extensions present inside the user device or computing device 104. The scanning may be performed to obtain a match with the predefined keywords, which may be set by the organization or the enterprise for identifying as sensitive or confidential information. The predefined keywords may be set by the user 102 (e.g. the system or a network administrator). The predefined keywords may be stored in the database 202A. The scanning may be performed periodically scheduled or timely scheduled, as per the requirement of the user 102.

In one embodiment, the file formats supported by the risk scoring tool 104A may be TXT, RTF, DOC, DOCX, PPT, PPTX, XLS, XLSX, etc. but are not limited to the embodiments mentioned herein. In another embodiment, the risk scoring tool 104A may also support pdf (portable document format). The information log module 206 creates a log file while scanning the files and the file extensions in the user device 104. The log file may contain information on a device ID, a date (last modified), a location of said file, a name of said file, an extension type, sensitive content found based on said predefined keywords, a number of occurrences of said sensitive content, etc. but are not limited to the embodiments mentioned herein.

The log file may be communicated to a server or the parsing server 108 for further analysis on the information recorded inside the log file. The communication module 208A may transfer the log file from the user device 104 to the server 108. The communication module 208A may be connected to a network and use any network protocol to transfer the log file. The log file format may be a csv file format but not limited to the embodiments mentioned herein. The database 202A may store instructions to execute the modules, predefined keywords, log file, etc.

FIG. 2B illustrates an exploded view of the parsing server 108 of FIG. 1 according to an embodiment herein. The parsing server 108 may include a database 202B, a communication module 208B, a calculation module 210, and a risk score module 212. The communication module 208B may receive multiple log files from different user device or computing device 104. In one embodiment, the respective log file generated from each of the user device 104 in the network 106 may be received by the communication module 208B.

The calculation module 210, may collate multiple log files from multiple user device 104. The collated log files may be aggregated to derive information on the most sensitive user device 104, which may contain maximum sensitive information as per predefined keywords set by the organization or the enterprise. The derived information may be related to device ID, date (last modified), location of said file, name of said file, extension type, sensitive content found based the predefined keywords, number of occurrences of the sensitive content, etc. of each of the user device 104.

The calculation module 210 may send the derived information to the risk score module 212. The risk score module 212 may receive the derived information on the most sensitive user device in the network 106 or a group of devices within an organization. The risk score module 212 may assign the most sensitive user device in an ascending order in one example embodiment. The display unit 214 may display the result to the user 102. The result may be represented in the form of ranking, chart, graph, percentage, etc., in one example embodiment.

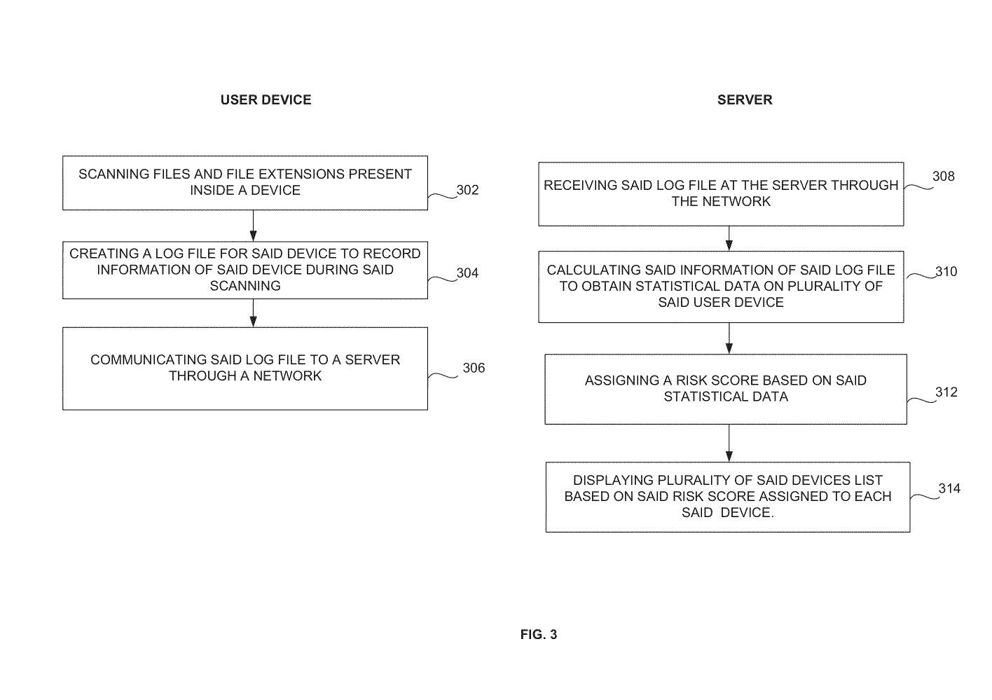

FIG. 3 is a flow diagram illustrating the method for providing risk score based on sensitive information inside user device according to an embodiment herein. In step 302, the scanning may be initialized to the files and the file extensions inside the user device 104 (e.g. through the scanning module 204). In step 304, a log file may be created (e.g. through the information log module 206) for each user device which is scanned in the network 106. In one embodiment multiple log files may be created for multiple user devices in the network 106.

In step 306, the log file may be transferred to the server or the parsing server 108 (e.g. through the communication module 208A). In one embodiment, multiple log files may be transferred from multiple user devices in the network 106. In step 308, the log file may be received from by the server or the parsing server 108 (e.g. through the communication module 208B). In another embodiment, multiple log files may be received from multiple user devices in the network 106.

In step 310, the log file is calculated for its information on the sensitive data on the user device 104. In step 312, a risk score may be assigned (e.g. through the risk scoring module 212), to the user device 104. The risk score may be assigned based on information of highest sensitive data contained in the user device 104. The risk score may be assigned in the ascending order to the highest sensitive user device in the network 106. In step 314, the list of the user device 104 may be displayed (e.g. through the display unit 406), based on the sensitive information contained in the user device 104.

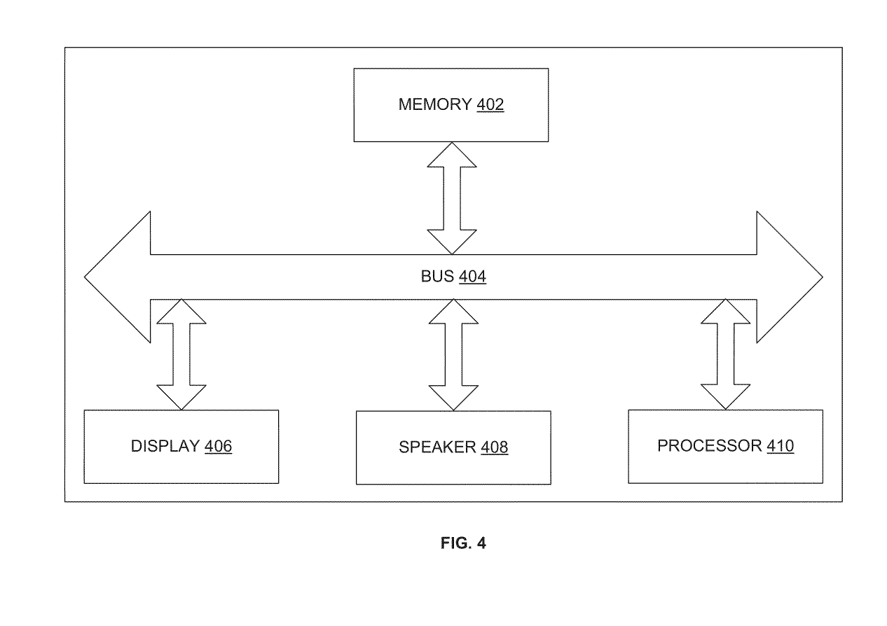

FIG. 4 illustrates an exploded view of a receiver of having an a memory 402 having a set of computer instructions, a bus 404, a display 406, a speaker 408, and a processor 410 capable of processing a set of instructions to perform any one or more of the methodologies herein, according to an embodiment herein. The processor 410 may also enable digital content to be consumed in the form of video for output via one or more displays 406 or audio for output via speaker and/or earphones 408. The processor 410 may also carry out the methods described herein and in accordance with the embodiments herein.

Digital content may also be stored in the memory 402 for future processing or consumption. The memory 402 may also store program specific information and/or service information (PSI/SI), including information about digital content (e.g., the detected information bits) available in the future or stored from the past. A user of the receiver may view this stored information on display 406 and select an item of for viewing, listening, or other uses via input, which may take the form of keypad, scroll, or other input device(s) or combinations thereof. When digital content is selected, the processor 410 may pass information. The content and PSI/SI may be passed among functions within the receiver using the bus 404.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections).

In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

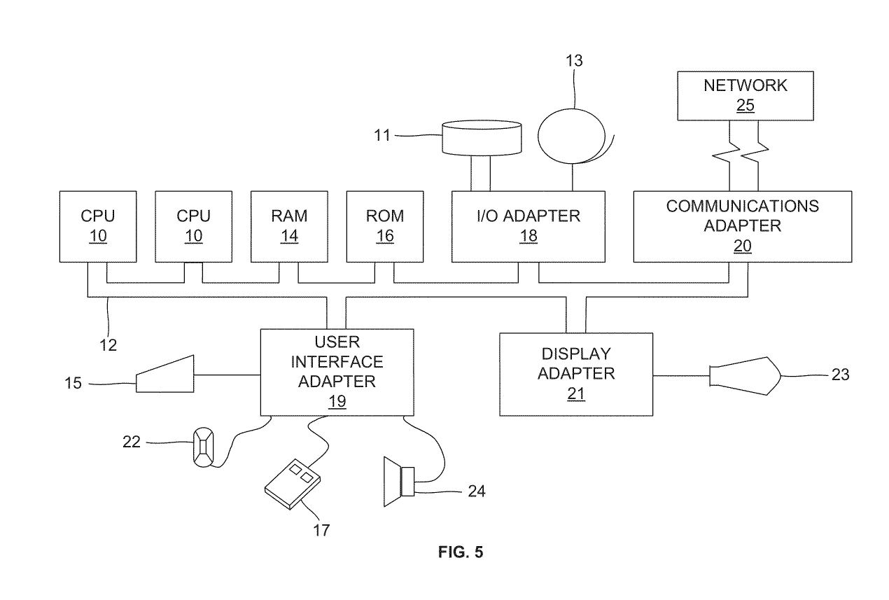

A representative hardware environment for practicing the embodiments herein is depicted in FIG. 5. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The method may facilitate the user 102 (e.g. the system or the network administrator), to identify the devices in the network 106, which may contain the most sensitive information related to the enterprise or the organization. This identification may help the system administrator to take corrective action in case of network failure or potential external threat. This may also help in taking data backup in advance for case of data crash or device loss. The risk scoring tool 104A enables the organization or the enterprise to prioritize their security and backup policy based on identification of the most sensitive device connected in their network or group.

The risk scoring tool 104A may be installed and supported on varied operating system environments. The operating system environment may include but not limited to Android®, iOS®, RIM®, Windows®, etc. In one embodiment, risk score may be used by an antivirus software program vendor, to target and prioritize a virus scan on those systems which have a greater risk score i.e. with most sensitive data as predefined by the organizational needs.

In another embodiment, on a zero day threat where a virus signature may not have been developed by an antivirus vendor, a risk score of the devices in the network may help antivirus vendor to remove those critical systems from the network 106 which are most sensitive for the organization or the enterprise. An information breach may be prevented and virus or a rogue program may not send the sensitive data to an external source, till the signature of that virus or threat has been developed by the antivirus vendor. This method will prevent damage to the organizations sensitive data due to data breach by a virus or a rogue program.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. A server for providing risk score based on sensitive information inside a plurality of devices, said system comprising:
a memory that stores computer executable instructions, a set of modules and a database;
a display unit; and
a processor configured by said computer executable instructions, that executes said set of modules, said set of modules comprising:
a communication module, executed by said processor, that receives log files in said server, wherein said server is configured to receive multiple log files from said plurality of devices connected to said server through a network;
a calculation module, executed by said processor, that calculates information of said log files, wherein said log files comprises information on a device ID, a date of last modified file, a location of said file, a name of said file, an extension type, a sensitive content found based on said predefined keywords, and a number of occurrences of said sensitive content, related to plurality of said devices, to obtain a statistical data on said plurality of devices, having maximum match with said sensitive content found based on said predefined keywords, and said number of occurrences of said sensitive content; and
a risk score module, executed by said processor, that assigns a risk score to each said plurality of devices based on said statistical data;

2. The system of claim 1, wherein said plurality of devices is listed based on said risk score.

3. The system of claim 2, wherein said statistical data is displayed to a system administrator.

4. The system of claim 1, wherein said risk score is assigned to a group of devices within an enterprise.

5. The system of claim 1, wherein said device ID is unique to each said device.

6. The system of claim 1, wherein said risk score is set in ascending order for said plurality of devices having most sensitive information.

7. The system of claim 1, wherein said predefined keywords comprises set of words which are potentially related to confidential data of an enterprise.

8. The system of claim 1, wherein said predefined keywords is stored inside said database of said server.

9. A method implemented in a server for providing a risk score to a device based on sensitive information inside said device, said method comprising:
receiving log files in said server, wherein said server is configured to receive multiple log files from said plurality of devices connected to said server through a network;
calculating information of said log files, wherein said log files comprises information on a device ID, a date of last modified file, a location of said file, a name of said file, an extension type, a sensitive content found based on said predefined keywords, and a number of occurrences of said sensitive content, related to plurality of said devices, to obtain a statistical data on said plurality of devices, having maximum match with said sensitive content found based on said predefined keywords, and said number of occurrences of said sensitive content; and
assigning a risk score to each said plurality of devices based on said statistical data;

10. The method of claim 9, wherein said risk score is set in ascending order for said device comprising maximum sensitive information.

11. The method of claim 9, wherein said risk score is assigned to a group of device within an enterprise.

12. The method of claim 9, wherein said predefined keywords comprises set of words which are related to confidential data of an enterprise.

13. The method of claim 9, wherein said plurality of devices is listed based on said risk score.

14. The method of claim 9, said statistical data is displayed to a system administrator.

15. A method for providing risk score based on sensitive information inside plurality of devices, said method comprising;
scanning files and file extensions present inside said device, to obtain a keyword match with a predefined keywords, wherein said predefined keywords are stored inside a database in said device;
creating a log file for said plurality of devices that records a device ID, a date of last modified file, a location of said file, a name of said file, an extension type, a sensitive content found based on said predefined keywords, and a number of occurrences of said sensitive content; and
communicating said log file to a server through a network, wherein said server is configured to receive multiple log files from said plurality said device;

16. The method of claim 15, wherein said predefined keywords comprises set of words which are potentially related to confidential data of an enterprise.

17. The method of claim 15, wherein said files and file extensions supported by said plurality of devices is TXT, RTF, DOC, DOCX, PPT, PPTX, XLS, XLSX or like.

18. The method of claim 15, wherein said risk score is assigned to a group of devices within an enterprise.
